(19) United States
(12) Patent Application Publication
(10) Pub. No.: US 2026/0236849 A1
(43) Pub. Date: Aug. 13, 2026

(54) ONLINE OPTIMIZATION OF TUNABLE CONTINUOUS PARAMETERS OF A MACHINE LEARNING MODEL

(71) Applicant: ROKU, INC., San Jose, CA (US)

(72) Inventors: Zidong WANG, San Jose, CA (US); Yan Gao, Sunnyvale, CA (US); Abhishek Bambha, San Jose, CA (US); Fei Xiao, San Jose, CA (US)

(73) Assignee: ROKU, INC., San Jose, CA (US)

(21) Appl. No.: 19/639,479

(22) Filed: Apr. 6, 2026

Related U.S. Application Data
(63) Continuation-in-part of application No. 17/965,284, filed on Oct. 13, 2022.

(51) Int. Cl. G06N 20/00

(52) U.S. Cl. CPC G06N 20/00

(57) ABSTRACT

Disclosed herein are system, apparatus, article of manufacture, method and/or computer program product embodiments, and/or combinations and sub-combinations thereof, for optimizing continuous parameters in online recommendation systems. An example embodiment operates by generating a surrogate model including an updatable statistical model of one or more mappings from candidate configurations of tunable parameters of a target model to values of the objective function. The tunable parameters include a continuous parameter. The embodiment then selects, using an acquisition function and outputs from the surrogate model, candidate configurations of the tunable parameters having the continuous parameter. The embodiment then determines objective-function values that are indicative of performance measures of the target model for the selected candidate. The embodiment then updates the surrogate model. The embodiment then selects a configuration of the tunable parameters that include the continuous parameter having a value associated with an extremum of the performance measures of the target model.

### CROSS-REFERENCE TO RELATED APPLICATIONS

The present application is a continuation-in-part of U.S. Application No. 17/965,284, filed October 13, 2022, the content of which is incorporated herein by reference in its entirety.

### BACKGROUND

### FIELD

This disclosure is generally directed to online tuning of parameters of machine learning models, and more particularly to online optimization of tuning continuous parameters to provide a user experience to remote media devices that maximizes (or minimizes) an objective function with constraint.

### SUMMARY

Provided herein are system, apparatus, article of manufacture, method and/or computer program product embodiments, and/or combinations and sub-combinations thereof, for optimizing continuous parameters in online recommendation systems using Bayesian optimization.

An example embodiment operates by generating a surrogate model including an updatable statistical model of one or more mappings from candidate configurations of tunable parameters of a target model to values of the objective function that are indicative of a performance measure of the target model. The tunable parameters include a continuous parameter having a continuous range of selectable values. The embodiment then selects, using an acquisition function of the online optimizer and outputs from the surrogate model, candidate configurations of the tunable parameters that include the continuous parameter. The embodiment then determines, by applying the objective function to the target model configured with respective ones of the selected candidate configurations, objective-function values that are indicative of performance measures of the target model for the selected candidate configurations. The embodiment then updates the surrogate model using the selected candidate configurations and the objective-function values. The embodiment then selecting, based on the updated surrogate model and an iteration termination condition, a configuration of the tunable parameters that include the continuous parameter having a value associated with an extremum of the performance measures of the target model. The embodiment then provides, using the target model and the selected configuration, the user experience to one or more of the media devices.

In an embodiment, the online optimizer is a Bayesian optimizer.

An embodiment includes updating the acquisition function using the updated surrogate model. The embodiment then determines, using the updated acquisition function, a candidate configuration of the tunable parameters that includes the continuous parameter.

An embodiment includes receiving, from one or more of the media devices, usage data associated with the user experience.

An embodiment includes applying a Bayesian noise filter to the received usage data.

In an embodiment, determining the objective-function values includes processing the usage data based on outputs of the target model configured with the respective ones of the selected candidate configurations.

An embodiment includes extracting performance measures from the usage data based on outputs of the target model configured with the respective ones of the selected candidate configurations.

An embodiment includes aggregating the extracted performance measures.

An example embodiment includes a system including one or more memories and at least one processor each coupled to at least one of the memories and configured to perform operations. The operations include generating a surrogate model including an updatable statistical model of one or more mappings from candidate configurations of tunable parameters of a target model to values of an objective function of an online optimizer that are indicative of a performance measure of the target model. The tunable parameters include a continuous parameter having a continuous range of selectable values. The operations further include selecting, using an acquisition function of the online optimizer and outputs from the surrogate model, candidate configurations of the tunable parameters that include the continuous parameter. The operations further include determining, by applying the objective function to the target model configured with respective ones of the selected candidate configurations, objective-function values that are indicative of performance measures of the target model for the selected candidate configurations. The operations further include updating the surrogate model using the selected candidate configurations and the objective-function values. The operations further include selecting, based on the updated surrogate model and an iteration termination condition, a configuration of the tunable parameters that includes the continuous parameter having a value associated with an extremum of the performance measures of the target model. The operations further include providing, using the target model and the selected configuration, the user experience to one or more of the media devices.

An example embodiment includes a non-transitory computer-readable medium having instructions stored thereon. The instructions, when executed by at least one computing device, cause the at least one computing device to perform operations. The operations include generating a surrogate model including an updatable statistical model of one or more mappings from candidate configurations of tunable parameters of a target model to values of an objective function of an online optimizer that are indicative of a performance measure of the target model. The tunable parameters include a continuous parameter having a continuous range of selectable values. The operations further include selecting, using an acquisition function of the online optimizer and outputs from the surrogate model, candidate configurations of the tunable parameters that include the continuous parameter. The operations further include determining, by applying the objective function to the target model configured with respective ones of the selected candidate configurations, objective-function values that are indicative of performance measures of the target model for the selected candidate configurations. The operations further include updating the surrogate model using the selected candidate configurations and the objective-function values. The operations further include selecting, based on the updated surrogate model and an iteration termination condition, a configuration of the tunable parameters that includes the continuous parameter having a value associated with an extremum of the performance measures of the target model. The operations further include providing, using the target model and the selected configuration, the user experience to one or more of the media devices.

### BRIEF DESCRIPTION OF THE FIGURES

The accompanying drawings are incorporated herein and form a part of the specification.

FIG. 1 illustrates a block diagram of a multimedia environment, according to some embodiments.

FIG. 2 illustrates a block diagram of a streaming media device, according to some embodiments.

FIG. 3 is a flowchart illustrating a method for providing a user experience to media devices that maximizes (or minimizes) an objective function, according to some embodiments.

FIG. 4 is a flowchart illustrating a method for optimizing continuous parameters in online recommendation systems using Bayesian optimization, according to some embodiments.

FIG. 5 is a flowchart illustrating a method for providing a user experience to media devices via network based on optimization of an objective function of an online optimizer, according to some embodiments.

FIG. 6 illustrates an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for addressing challenges of conventional static parameter tuning approaches that operate on parameters that can take on a finite number of discrete values (discrete parameters). Conventional approaches may fail to adapt to evolving online conditions, thereby preventing systems from maximizing dynamic business rewards such as ad revenue, subscription revenue, and user engagement metrics. Furthermore, parameters that can take on any value from an infinite possibility range (e.g., continuous parameters) may significantly increase the number of tries and amount of time it takes to approach an optimum value. Bayesian optimization provides a method for choosing the most promising parameter candidates for testing during the optimization process. The system may employ surrogate models to efficiently navigate high-dimensional parameter spaces while managing reward signal noise inherent in online environments through custom noise reduction techniques. In some embodiments, optimization is performed by combining one or more objective measures with one or more constraint measures, such that parameter selection seeks to optimize business objectives while satisfying operational or user-experience constraints. This approach may extend beyond discrete parameter optimization methods to enable real-time adaptation of recommendation system parameters based on observed user behavior and business performance metrics, creating a closed-loop optimization system that may continuously improve system performance in production environments.

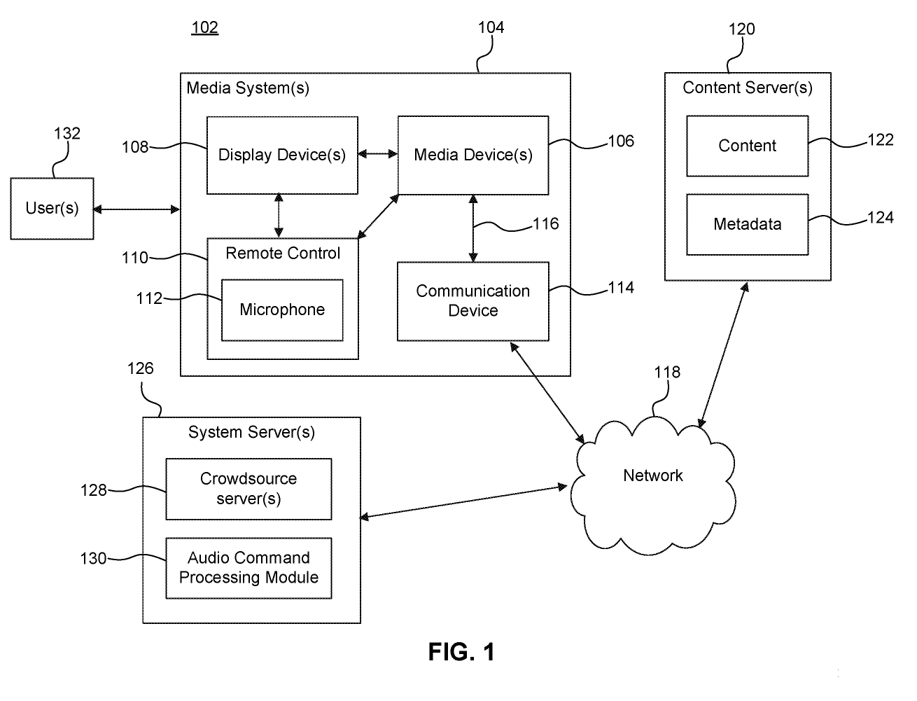

Various embodiments of this disclosure may be implemented using and/or may be part of a multimedia environment 102 shown in FIG. 1. It is noted, however, that multimedia environment 102 is provided solely for illustrative purposes, and is not limiting. Embodiments of this disclosure may be implemented using and/or may be part of environments different from and/or in addition to the multimedia environment 102, as will be appreciated by persons skilled in the relevant art(s) based on the teachings contained herein. An example of the multimedia environment 102 shall now be described.

### Multimedia Environment

FIG. 1 illustrates a block diagram of a multimedia environment 102, according to some embodiments. In a non-limiting example, multimedia environment 102 may be directed to streaming media. However, this disclosure is applicable to any type of media (instead of or in addition to streaming media), as well as any mechanism, means, protocol, method and/or process for distributing media.

The multimedia environment 102 may include one or more media systems 104. A media system 104 could represent a family room, a kitchen, a backyard, a home theater, a school classroom, a library, a car, a boat, a bus, a plane, a movie theater, a stadium, an auditorium, a park, a bar, a restaurant, or any other location or space where it is desired to receive and play streaming content. User(s) 132 may operate with the media system 104 to select and consume content.

Each media system 104 may include one or more media devices 106 each coupled to one or more display devices 108. It is noted that terms such as “coupled,” “connected to,” “attached,” “linked,” “combined” and similar terms may refer to physical, electrical, magnetic, logical, etc., connections, unless otherwise specified herein.

Media device 106 may be a streaming media device, DVD or BLU-RAY device, audio/video playback device, cable box, and/or digital video recording device, to name just a few examples. Display device 108 may be a monitor, television (TV), computer, smart phone, tablet, wearable (such as a watch or glasses), appliance, internet of things (IoT) device, and/or projector, to name just a few examples. In some embodiments, media device 106 may be a part of, integrated with, operatively coupled to, and/or connected to its respective display device 108.

Each media device 106 may be configured to communicate with network 118 via a communication device 114. The communication device 114 may include, for example, a cable modem or satellite TV transceiver. The media device 106 may communicate with the communication device 114 over a link 116, wherein the link 116 may include wireless (such as WiFi) and/or wired connections.

In various embodiments, the network 118 may include, without limitation, wired and/or wireless intranet, extranet, Internet, cellular, Bluetooth, infrared, and/or any other short range, long range, local, regional, global communications mechanism, means, approach, protocol and/or network, as well as any combination(s) thereof.

Media system 104 may include a remote control 110. The remote control 110 may be any component, part, apparatus and/or method for controlling the media device 106 and/or display device 108, such as a remote control, a tablet, laptop computer, smartphone, wearable, on-screen controls, integrated control buttons, audio controls, or any combination thereof, to name just a few examples. In an embodiment, the remote control 110 wirelessly communicates with the media device 106 and/or display device 108 using cellular, Bluetooth, infrared, etc., or any combination thereof. The remote control 110 may include a microphone 112, which is further described below.

The multimedia environment 102 may include a plurality of content servers 120 (also called content providers, channels or sources 120). Although only one content server 120 is shown in FIG. 1, in practice the multimedia environment 102 may include any number of content servers 120. Each content server 120 may be configured to communicate with network 118.

Each content server 120 may store content 122 and metadata 124. Content 122 may include any combination of music, videos, movies, TV programs, multimedia, images, still pictures, text, graphics, gaming applications, advertisements, programming content, public service content, government content, local community content, software, and/or any other content or data objects in electronic form.

In some embodiments, metadata 124 comprises data about content 122. For example, metadata 124 may include associated or ancillary information indicating or related to writer, director, producer, composer, artist, actor, summary, chapters, production, history, year, trailers, alternate versions, related content, applications, and/or any other information pertaining or relating to the content 122. Metadata 124 may also or alternatively include links to any such information pertaining or relating to the content 122. Metadata 124 may also or alternatively include one or more indexes of content 122, such as but not limited to a trick mode index.

The multimedia environment 102 may include one or more system servers 126. The system servers 126 may operate to support the media devices 106 from the cloud. It is noted that the structural and functional aspects of the system servers 126 may wholly or partially exist in the same or different ones of the system servers 126.

The media devices 106 may exist in thousands or millions of media systems 104. Accordingly, the media devices 106 may lend themselves to crowdsourcing embodiments and, thus, the system servers 126 may include one or more crowdsource servers 128.

For example, using information received from the media devices 106 in the thousands and millions of media systems 104, the crowdsource server(s) 128 may identify similarities and overlaps between closed captioning requests issued by different users 132 watching a particular movie. Based on such information, the crowdsource server(s) 128 may determine that turning closed captioning on may enhance users’ viewing experience at particular portions of the movie (for example, when the soundtrack of the movie is difficult to hear), and turning closed captioning off may enhance users’ viewing experience at other portions of the movie (for example, when displaying closed captioning obstructs critical visual aspects of the movie). Accordingly, the crowdsource server(s) 128 may operate to cause closed captioning to be automatically turned on and/or off during future streamings of the movie.

The system servers 126 may also include an audio command processing module 130. As noted above, the remote control 110 may include a microphone 112. The microphone 112 may receive audio data from users 132 (as well as other sources, such as the display device 108). In some embodiments, the media device 106 may be audio responsive, and the audio data may represent verbal commands from the user 132 to control the media device 106 as well as other components in the media system 104, such as the display device 108.

In some embodiments, the audio data received by the microphone 112 in the remote control 110 is transferred to the media device 106, which is then forwarded to the audio command processing module 130 in the system servers 126. The audio command processing module 130 may operate to process and analyze the received audio data to recognize the user 132’s verbal command. The audio command processing module 130 may then forward the verbal command back to the media device 106 for processing.

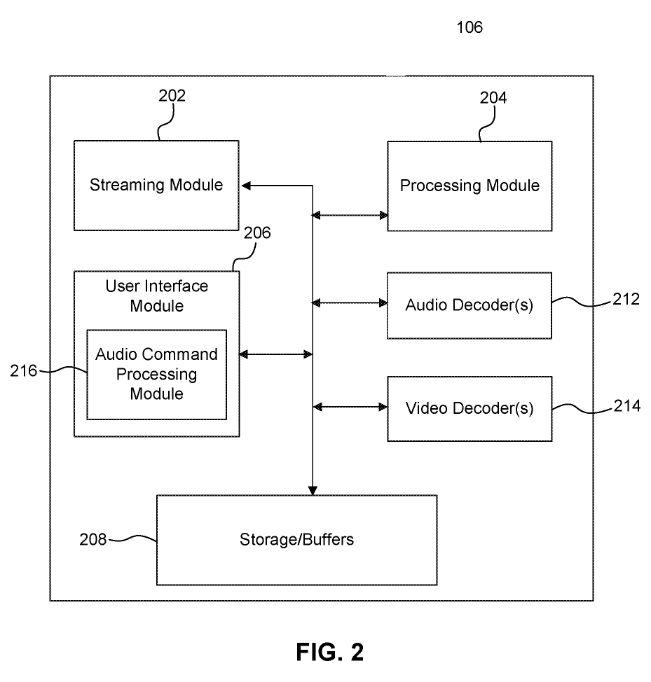

In some embodiments, the audio data may be alternatively or additionally processed and analyzed by an audio command processing module 216 in the media device 106 (see FIG. 2). The media device 106 and the system servers 126 may then cooperate to pick one of the verbal commands to process (either the verbal command recognized by the audio command processing module 130 in the system servers 126, or the verbal command recognized by the audio command processing module 216 in the media device 106).

FIG. 2 illustrates a block diagram of an example media device 106, according to some embodiments. Media device 106 may include a streaming module 202, processing module 204, storage/buffers 208, and user interface module 206. As described above, the user interface module 206 may include the audio command processing module 216.

The media device 106 may also include one or more audio decoders 212 and one or more video decoders 214.

Each audio decoder 212 may be configured to decode audio of one or more audio formats, such as but not limited to AAC, HE-AAC, AC3 (Dolby Digital), EAC3 (Dolby Digital Plus), WMA, WAV, PCM, MP3, OGG GSM, FLAC, AU, AIFF, and/or VOX, to name just some examples.

Similarly, each video decoder 214 may be configured to decode video of one or more video formats, such as but not limited to MP4 (mp4, m4a, m4v, f4v, f4a, m4b, m4r, f4b, mov), 3GP (3gp, 3gp2, 3g2, 3gpp, 3gpp2), OGG (ogg, oga, ogv, ogx), WMV (wmv, wma, asf), WEBM, FLV, AVI, AV1, QuickTime, HDV, MXF (OP1a, OP-Atom), MPEG-TS, MPEG-2 PS, MPEG-2 TS, WAV, Broadcast WAV, LXF, GXF, and/or VOB, to name just some examples. Each video decoder 214 may include one or more video codecs, such as but not limited to H.263, H.264, H.265, AVI, AV1, HEV, MPEG1, MPEG2, MPEG-TS, MPEG-4, Theora, 3GP, DV, DVCPRO, DVCPRO, DVCProHD, IMX, XDCAM HD, XDCAM HD422, and/or XDCAM EX, to name just some examples.

Now referring to both FIGS. 1 and 2, in some embodiments, the user 132 may interact with the media device 106 via, for example, the remote control 110. For example, the user 132 may use the remote control 110 to interact with the user interface module 206 of the media device 106 to select content, such as a movie, TV show, music, book, application, game, etc. The streaming module 202 of the media device 106 may request the selected content from the content server(s) 120 over the network 118. The content server(s) 120 may transmit the requested content to the streaming module 202. The media device 106 may transmit the received content to the display device 108 for playback to the user 132.

In streaming embodiments, the streaming module 202 may transmit the content to the display device 108 in real time or near real time as it receives such content from the content server(s) 120. In non-streaming embodiments, the media device 106 may store the content received from content server(s) 120 in storage/buffers 208 for later playback on display device 108.

### Online Automatic Hyperparameter Tuning

Referring again to FIG. 1, system servers 126 may provide a user experience to media devices 106. For example, a recommender running on system servers 126 may control how content recommendations are provided to media devices 106. System servers 126 may also control how a user interface is displayed on media devices 106. System servers 126 may use online automatic hyperparameter tuning of a machine learning model (or engineering logic) to provide an optimal user experience to media devices 106. For example, system servers 126 may use online automatic hyperparameter tuning of a machine learning model (or engineering logic) to provide a user experience to media devices 106 that maximizes (or minimizes) an objective function (e.g., a business target such as total advertising revenue per session). The recommender may be the machine learning model itself (or engineering logic) or include the machine learning model (or engineering logic) as part of a more comprehensive user experience curator algorithm. While the below discussion describes an example of online automatic hyperparameter tuning of a machine learning model to provide an optimal user experience to media devices 106, it is not limited to online automatic hyperparameter tuning of a machine learning model to provide an optimal user experience to media devices 106. The described online automatic hyperparameter tuning may also be used to tune an engineering logic to provide an optimal user experience to media devices 106.

As discussed above, system servers 126 may provide a user experience to media devices 106 according to a machine learning model (or engineering logic). The machine learning model (or engineering logic) may control how a user experience is provided to media devices 106. For example, the machine learning model (or engineering logic) may control how content recommendations are provided media devices 106. The machine learning model (or engineering logic) may also control how a user interface is displayed on media devices 106.

The machine learning model may determine what type of user experience to provide media devices 106 based on its model parameters. A machine learning model parameter may be a configuration variable that is internal to the machine learning model (e.g., the weights in an artificial neural network, support vectors in a support vector machine, or coefficients in a linear regression or logistic regression). The values of machine learning model parameters may define how the model maps input data to output data (e.g., makes predictions or provides a particular user experience for a particular media device 106). The values of machine learning model parameters may be estimated or learned from data. For example, the values of machine learning model parameters may be learned by training the model using training data according to a learning algorithm.

Hyperparameters may be used to estimate machine learning model parameters (or tune an engineering logic). A hyperparameter may be a configuration variable that is external to the machine learning model and whose value may be used to control the learning process. For example, a hyperparameter may be a learning rate for training a neural network, the penalty (e.g., C) and sigma (e.g., σ) hyperparameters for support vector machines, or the k in k-nearest neighbors. The same kind of machine learning model may require different hyperparameter values to generalize different data patterns. Thus, the hyperparameters of the machine learning model may need to be tuned in order to discover the model parameters of the model that result in the most skillful predictions.

But there may be many (e.g., hundreds) hyperparameters that may need to be tuned in order to discover the machine learning model parameters of the model that provide an optimal solution for a given problem (e.g., providing a user experience to media devices 106 that maximizes (or minimizes) some objective function such as, but not limited to, maximizing advertising revenue per session). Moreover, it is often unclear the relationship between these hyperparameters and the given problem. In other words, it often unclear the best values for these hyperparameters on the given problem. As a result, these hyperparameters are often tuned offline and fixed when the machine learning model is used in the online environment (e.g., multimedia environment 102). But tuning these hyperparameters offline often produces a machine learning model that provides a suboptimal user experience to media devices 106.

To solve these technological problems, system servers 126 may use online automatic hyperparameter tuning of a machine learning model (or engineering logic) to provide a user experience to media devices 106 that maximizes (or minimizes) an objective function. System servers 126 may generate an initial set of hyperparameter configurations for a machine learning model (or engineering logic) that provides a user experience to media devices 106. Each hyperparameter configuration may represent values for hyperparameters of the machine learning model (or engineering logic). System servers 126 may generate the initial set of hyperparameter configurations based on sampling data received from media devices 106 (e.g., over network 118). System servers 126 may also generate the initial set of hyperparameter configurations based on historical offline data associated with media devices 106. And system servers 126 may generate the initial set of hyperparameter configurations based on sampling data received from media devices 106 and historical offline data associated with media devices 106. As would be appreciated by a person of ordinary skill in the art, system servers 126 may generate the initial set of hyperparameter configurations based on various other data and/or combinations of data.

The initial set of hyperparameter configurations may be associated with a learning algorithm that may be used train the machine learning model (or tune the engineering logic). As would be appreciated by a person of ordinary skill in the art, various learning algorithms may be used to train the machine learning model (or tune the engineering logic). For example, the Upper Confidence Bound (UCB) algorithm may be used to train the machine learning model. The Thompson Sampling algorithm may also be used to train the machine learning model. And the Cross Entropy Method (CEM) may be used to train the machine learning model.

The chosen learning algorithm may define different hyperparameters for estimating or learning the model parameters for the machine learning model (or tuning the engineering logic). In other words, different learning algorithms may utilize different hyperparameters. For example, a learning algorithm may use a learning rate. For support vector machines, the hyperparameters may include the penalty (e.g., C) and/or sigma (e.g., σ) parameters. For artificial neural networks, the hyperparameters may include a number of layers and/or a number of neurons per layer. For a k-means clustering algorithm, the hyperparameters may include the number of clusters.

After generating the initial set of hyperparameter configurations, system servers 126 may determine, using a hyperparameter tuning method, a hyperparameter configuration that causes a training of the machine learning model (or tuning of the engineering logic) using a learning algorithm to maximize (or minimize) an objective function. For example, system servers 126 may determine, using a hyperparameter tuning method, a hyperparameter configuration that causes a training of the machine learning model using its associated learning algorithm such that it provides a user experience to media devices 106 that maximizes (or minimizes) an objective function. System servers 126 may determine the hyperparameter configuration based on the initial set of hyperparameter configurations.

System servers 126 may determine the hyperparameter configuration using various hyperparameter tuning methods as would be appreciated by a person of ordinary skill in the art. For example, system servers 126 may determine the hyperparameter configuration using a grid search algorithm. System servers 126 may also determine the hyperparameter configuration using a random search algorithm. System servers 126 may also determine the hyperparameter configuration using a Bayesian optimization algorithm. System servers 126 may also determine the hyperparameter configuration using a gradient-based optimization algorithm. System servers 126 may also determine the hyperparameter configuration using an evolutionary optimization algorithm. System servers 126 may also determine the hyperparameter configuration using a population-based training algorithm. And system servers 126 may determine the hyperparameter configuration using an early-stopping-based algorithm.

System servers 126 may determine, using the hyperparameter tuning method, the hyperparameter configuration that causes a training of the machine learning model (or tuning of the engineering logic) using its associated learning algorithm such that it provides a user experience to media devices 106 that maximizes (or minimizes) an objective function. System servers 126 may attempt to maximize (or minimize) various objective functions. System servers 126 may attempt to maximize (or minimize) an objective function that is based on a business target. For example, system servers 126 may attempt to maximize(or minimize) the total advertisement revenue per session. System servers 126 may also attempt to maximize (or minimize) an objective function that is based on other targets such as, but not limited to, computational efficiency, computer memory utilization, and/or power efficiency.

After determining the hyperparameter configuration, system servers 126 may train the machine learning model (or tune the engineering logic) according to the determined hyperparameter configuration using its associated learning algorithm. System servers 126 may then use the trained machine learning model to provide a user experience to media devices 106. For example, system servers 126 may use the trained machine learning model to provide an optimal user interface to media devices 106. System server 126 may also use the trained machine learning model to provide optimal content recommendations to media devices 106. Because the machine learning model was trained according to a hyperparameter configuration determined from online data from media devices 106 to maximize (or minimize) an objective function, system servers 126 may ensure with high likelihood that using this trained machine learning model to provide a user experience to media devices 106 will maximize (or minimize) the objective function (e.g., total advertisement revenue per session).

To further improve the providing of a user experience to media devices 106 that will maximize (or minimize) the objective function (e.g., total advertisement revenue per session), system servers 126 may periodically repeat the above process. In other words, system servers 126 may repeatedly: generate an initial set of hyperparameter configurations based on sampling data received from media devices 106, determine a hyperparameter configuration based on the initial set of hyperparameter configurations that causes a training of the machine learning model (or a tuning of an engineering logic) such that maximizes (or minimizes) the objective function, train the machine learning model (or tune the engineering logic) using the determined hyperparameter configuration, and provide, using the trained machine learning model (or tuned engineering logic), an updated user experience to media devices 106. System servers 126 may periodically repeat this process according to a schedule. For example, system servers 126 may repeat this process every hour, day, or week. The schedule may be based on various characteristics of the media devices 106, the users operating media devices 106, or both. The schedule may be based on various other characteristics as would be appreciated by a person of ordinary skill in the art.

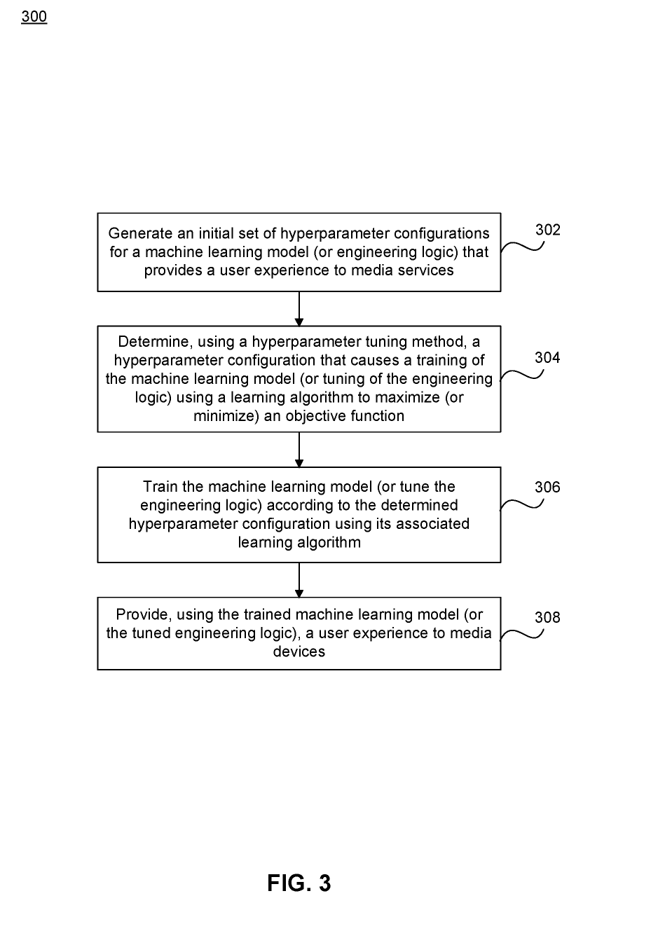

FIG. 3 is a flowchart for a method 300 for providing a user experience to media devices that maximizes (or minimizes) an objective function, according to an embodiment. Method 300 may be performed by processing logic that may comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 3, as will be understood by a person of ordinary skill in the art.

Method 300 shall be described with reference to FIG. 1. However, method 300 is not limited to that example embodiment.

In some embodiments, at step 302, system server 126 generates an initial set of hyperparameter configurations for a machine learning model (or engineering logic) that provides a user experience to media devices 106. System server 126 may generate the initial set of hyperparameter configurations based on sampling data received from media devices 106 (e.g., over network 118). System servers 126 may also generate the initial set of hyperparameter configurations based on historical offline data associated with media devices 106. And system servers 126 may generate the initial set of hyperparameter configurations based on sampling data received from media devices 106 and historical offline data associated with media devices 106. As would be appreciated by a person of ordinary skill in the art, system servers 126 may generate the initial set of hyperparameter configurations based on various other data and/or combinations of data.

The initial set of hyperparameter configurations may be associated with a learning algorithm that may be used train the machine learning model (or tune the engineering logic). As would be appreciated by a person of ordinary skill in the art, various learning algorithms may be used to train the machine learning model (or tune the engineering logic). For example, the UCB algorithm may be used to train the machine learning model. The Thompson Sampling algorithm may also be used to train the machine learning model. And the CEM may be used to train the machine learning model.

In some embodiments, at step 304, system server 126 determines, using a hyperparameter tuning method, a hyperparameter configuration that causes a training of the machine learning model (or tuning of the engineering logic) using a learning algorithm to maximize (or minimize) an objective function. For example, system server 126 may determine, using the hyperparameter tuning method, the hyperparameter configuration that causes a training of the machine learning model using its associated learning algorithm such that it provides a user experience to media devices 106 that maximizes (or minimizes) the objective function. System servers 126 may determine the hyperparameter configuration based on the initial set of hyperparameter configurations.

System servers 126 may determine the hyperparameter configuration using various hyperparameter tuning methods as would be appreciated by a person of ordinary skill in the art. For example, system servers 126 may determine the hyperparameter configuration using a grid search algorithm. System servers 126 may also determine the hyperparameter configuration using a random search algorithm. System servers 126 may also determine the hyperparameter configuration using a Bayesian optimization algorithm. System servers 126 may also determine the hyperparameter configuration using a gradient-based optimization algorithm. System servers 126 may also determine the hyperparameter configuration using an evolutionary optimization algorithm. System servers 126 may also determine the hyperparameter configuration using a population-based training algorithm. And system servers 126 may determine the hyperparameter configuration using an early-stopping-based algorithm.

System servers 126 may determine, using the hyperparameter tuning method, the hyperparameter configuration that causes a training of the machine learning model (or tuning of the engineering logic) using its associated learning algorithm such that it provides a user experience to media devices 106 that maximizes (or minimizes) an objective function. System servers 126 may attempt to maximize (or minimize) various objective functions. System servers 126 may attempt to maximize (or minimize) an objective function that is based on a business target. For example, system servers 126 may attempt to maximize (or minimize) the total advertisement revenue per session. System servers 126 may also attempt to maximize (or minimize) an objective function that is based on other targets such as, but not limited to, computational efficiency, computer memory utilization, and/or power efficiency.

In some embodiments, at step 306, system server 126 trains the machine learning model (or tunes the engineering logic) according to the determined hyperparameter configuration using its associated learning algorithm.

In some embodiments, at step 308, system server 126 provides, using the trained machine learning model (or tuned the engineering logic), a user experience to media devices 106. In other words, system server 126 provides, using the trained machine learning model, a user experience to media devices 106 that maximizes (or minimizes) the objective function.

To further improve the providing of a user experience to media devices 106 that will maximize (or minimize) the objective function (e.g., total advertisement revenue per session), system server 126 may periodically repeat method 300. System server 126 may repeat method 300 according to a schedule. For example, system server 126 may repeat method 300 every hour, day, or week. The schedule may be based on various characteristics of the media devices 106, the users operating media devices 106, or both. The schedule may be based on various other characteristics as would be appreciated by a person of ordinary skill in the art.

Online Bayesian Optimization and Continuous Hyperparameters

Alluded above were different algorithms for tuning hyperparameters, such as a Bayesian optimization algorithm. Provided herein are system, apparatus, device, method and/or computer program product embodiments, and/or combinations and sub-combinations thereof, for optimizing continuous parameters in online recommenders that are tuned using Bayesian optimization (e.g., running on system servers 126). Some embodiments may address the challenges of conventional static parameter tuning approaches that may fail to adapt to evolving online conditions, thereby preventing systems from maximizing dynamic business rewards such as ad revenue, subscription revenue, and user engagement metrics. In some embodiments, a Bayesian optimization framework may be integrated into an online learning system to continuously optimize tunable parameters (e.g., hyperparameters) that exist on continuous scales rather than discrete values.

Continuous parameters are those whose values that may be chosen from among an infinite number of possible values, such as any real number in a continuous range of selectable values. In some embodiments, the tunable parameters include one or more continuous parameters, enabling simultaneous optimization across multiple continuous dimensions rather than a single scalar variable. Continuous parameters pose a challenge from an online optimization standpoint (e.g., a finite number of values to test versus an infinite number of values to test). Bayesian optimization provides a method for choosing the most promising parameter candidates for testing during the optimization process. The system may employ surrogate models to efficiently navigate high-dimensional parameter spaces while managing reward signal noise inherent in online environments through custom noise reduction techniques. This approach may extend beyond discrete parameter optimization methods to enable real-time adaptation of recommendation system parameters based on observed user behavior and business performance metrics, creating a closed-loop optimization system that may continuously improve system performance in production environments.

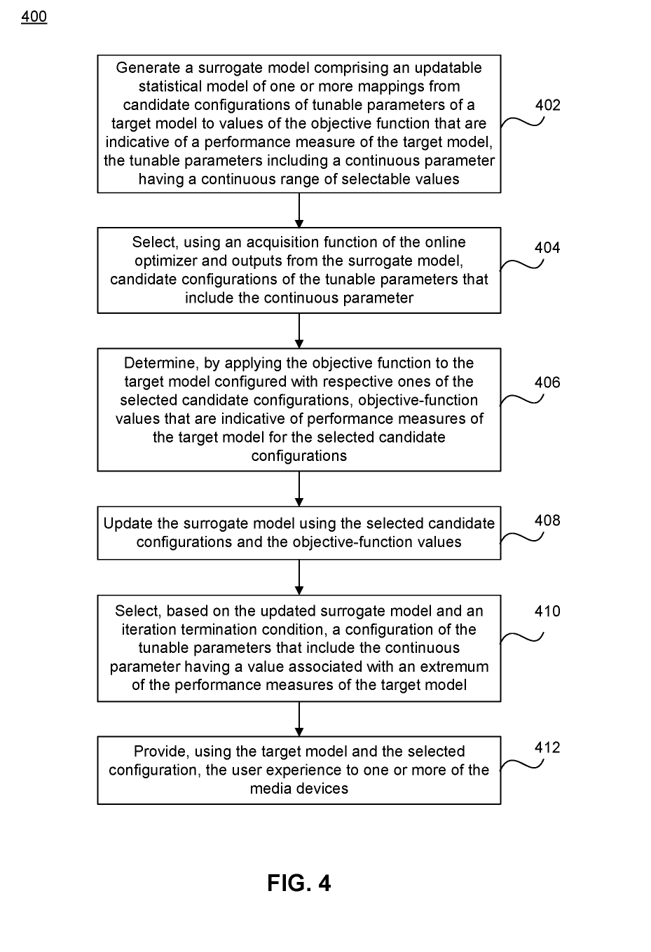

FIG. 4 is a flowchart for a method 400 for optimizing continuous parameters in online recommendation systems using Bayesian optimization, according to some embodiments. Method 400 may be performed by processing logic that may include hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 4, as will be understood by a person of ordinary skill in the art.

Method 400 shall be described with reference to FIGS. 1 and 2. However, method 400 is not limited to that example embodiment.

In some embodiments, at step 402, system servers 126 may generate a surrogate model including an updatable statistical model of one or more mappings. The mappings may be from candidate configurations of tunable parameters (e.g., optimizable hyperparameters) of a target model to values of the objective function that are indicative of a performance measure of the target model. The target model may mature into a deployable trained model when tunable parameter values are finalized at the end of the optimization process. The tunable parameters may include a continuous parameter having a continuous range of selectable values. In some embodiments, multiple tunable parameters (e.g., multiple continuous parameters) may be optimized jointly, such that candidate configurations represent simultaneous settings of two or more parameters rather than tuning a single parameter in isolation. In some embodiments, the surrogate model may be implemented as a Gaussian Process that provides both predictions and uncertainty estimates for unobserved parameter configurations. The target model may be a recommendation model operating within media device 106, system servers 126, content servers 120, or other suitable hardware, where the continuous parameters influence aspects such as content ranking biases, boosting factors for specific content types, or mixing ratios between different content sources. Unlike discrete parameter spaces that limit choices to predefined options, the continuous parameter space allows selection of any real-valued parameter within specified ranges, enabling more precise optimization.

In some embodiments, at step 404, system servers 126 may select candidate configurations of the tunable parameters that include the continuous parameter. The selection may be performed using an acquisition function of the online optimizer and outputs from the surrogate model. The acquisition function may balance exploration of uncertain parameter regions with exploitation of configurations expected to yield high performance. This balancing makes Bayesian optimization suitable for intelligent exploration of the infinite possibility spaces of continuous parameters. For instance, when optimizing content boosting parameters for live sports content versus entertainment content within the recommendation algorithms of streaming module 202, the acquisition function may identify promising continuous parameter combinations that have not yet been thoroughly evaluated.

In some embodiments, at step 406, system servers 126 may determine objective-function values that are indicative of performance measures of the target model for the selected candidate configurations. The determining may be performed by applying the objective function to the target model configured with respective ones of the selected candidate configurations. The objective function may process real-world performance data collected from user interactions across the multimedia environment 102. For example, when users 132 interact with content recommendations through remote control 110 and display device 108, their engagement patterns, subscription behaviors, and viewing durations may be captured as usage data. This data may flow from media devices 106 through communication devices 114 and network 118 back to system servers 126, where the data may be processed to compute business metrics such as ad revenue, subscription revenue, streaming hours, or the like, that serve as the objective function values. In some embodiments, optimization is performed subject to one or more business constraints (e.g., such that the system seeks to maximize advertisement revenue while constraining overall user-streaming hours to remain within predefined limits).

In some embodiments, at step 408, system servers 126 may update the surrogate model using the selected candidate configurations and the objective-function values. The Bayesian optimization framework may incorporate the newly observed performance data to refine its understanding of the parameter-to-performance mapping. In an embodiment, a Bayesian noise filter may be applied to the collected usage data before updating the surrogate model, helping to mitigate inherent noise in online environments such as delayed subscription renewals, ad system outages, or data collection inconsistencies. The updated surrogate model may provide improved predictions and uncertainty estimates for future parameter selection iterations.

In some embodiments, at step 410, system servers 126 may select a configuration of the tunable parameters that include the continuous parameter having a value associated with an extremum of the performance measures of the target model (e.g., a maximum value or a minimum value of the objective function). The selection may be based on the updated surrogate model and an iteration termination condition. The iteration termination condition may be based on convergence criteria, budget constraints, or performance thresholds. For instance, the optimization process may terminate when the surrogate model indicates that further parameter exploration is unlikely to yield significant improvements in the target business metrics, or when a predetermined number of evaluation cycles have been completed.

In some embodiments, at step 412, system servers 126 may provide the user experience to one or more of the media devices 106. The providing may be performed using the target model and the selected configuration. The optimized continuous parameters may be deployed to the recommender. The tuned parameters allow more effective content ranking, improved content mixing strategies, and better alignment between user engagement and business objectives. Users 132 may experience more relevant content recommendations displayed on their display devices 108, while the system achieves improved performance on key business metrics such as subscription conversion, ad revenue optimization, and long-term user retention.

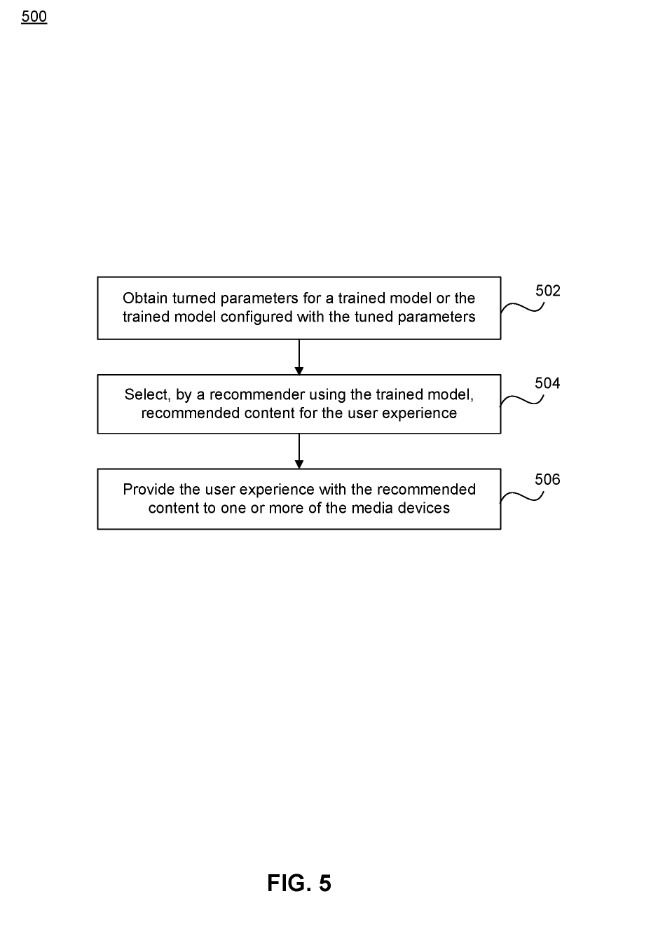

FIG. 5 is a flowchart for a method 500 for providing a user experience to media devices via network based on optimization of an objective function of an online optimizer, according to some embodiments. Method 500 may be performed by processing logic that may include hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 5, as will be understood by a person of ordinary skill in the art.

Method 500 shall be described with reference to FIGS. 1 and 2. However, method 500 is not limited to that example embodiment.

In some embodiments, at step 502, system servers 126 may obtain tuned parameters for a trained model or the trained model configured with the tuned parameters. The tuned parameters may be generated through an online optimizer where a surrogate model may be employed by the online optimizer to generate the tuned parameters (e.g., as in method 400 of FIG. 4). The surrogate model may include an updatable statistical model of one or more mappings from candidate configurations of tunable parameters of a target model to values of the objective function that are indicative of a performance measure of the target model. The tunable parameters may include a continuous parameter having a continuous range of selectable values. An acquisition function of the online optimizer and outputs from the surrogate model may be used to select candidate configurations of the tunable parameters that include the continuous parameter. Objective-function values may be determined by applying the objective function to the target model configured with respective ones of the selected candidate configurations. The objective-function values may be indicative of performance measures of the target model for the selected candidate configurations. The surrogate model may be updated using the selected candidate configurations and the objective-function values. Based on the updated surrogate model and an iteration termination condition, the tuned parameters may be selected from a configuration of the tunable parameters that includes the continuous parameter having a value associated with an extremum of the performance measures of the target model.

In some embodiments, at step 504, a recommender operating within system servers 126 may select, using the trained model, recommended content (e.g., from content 122) for the user experience. The recommender may use the optimized parameters obtained in step 502 to enhance content selection algorithms. These algorithms may determine optimal boosting factors for different content types (such as sports content, live content, or subscription-based content) to balance multiple business objectives including user engagement, subscription revenue, and advertisement revenue. The trained model may access content 122 and associated metadata 124 from content servers 120 via network 118 to make informed recommendations tailored to individual users 132.

In some embodiments, at step 506, system servers 126 may provide the user experience with the recommended content to one or more media devices 106. The optimized user experience may be delivered through the multimedia environment 102, where media devices 106 receive the recommended content via network 118. Users 132 may interact with the enhanced recommendations through their respective media systems 104, including display devices 108 and remote controls 110. The streaming module 202 of media device 106 may process the recommended content, while the user interface module 206 may present the optimized user experience. The continuous optimization framework ensures that the delivered content recommendations adapt dynamically to evolving user behavior and business requirements, providing improved performance across multiple metrics including user engagement, retention, and revenue generation. It is to be understood that, in some embodiments, methods 400 and 500 are not limited to optimization of one continuous parameter, but are directed to optimization of one or more continuous parameters. Instances in which a continuous parameter is optimized may as a result of being optimized by itself or among other tunable parameters that may or may not include another continuous parameter.

### Example Computer System

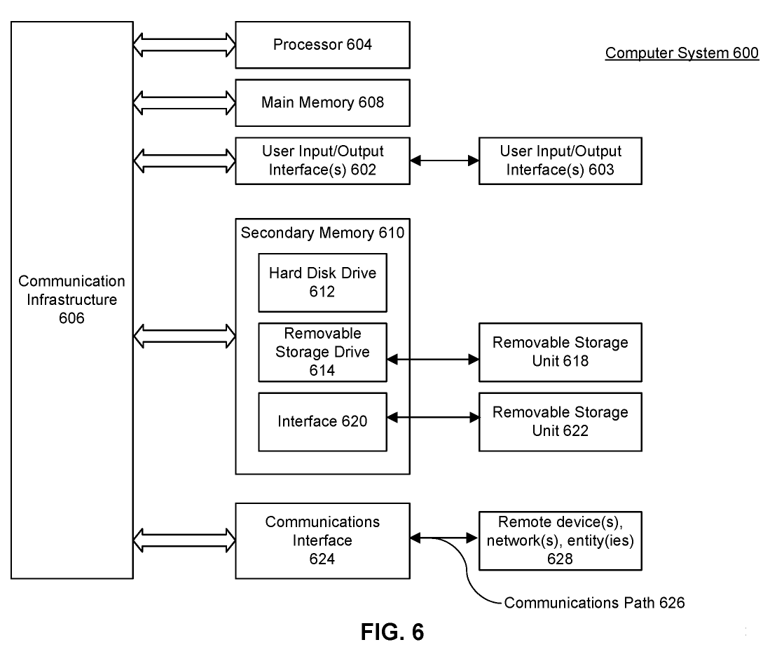

Various embodiments may be implemented, for example, using one or more well-known computer systems, such as computer system 600 shown in FIG. 6. For example, the media devices 106, content servers 120, system servers 126, or the like, may be implemented using combinations or sub-combinations of computer system 600. Also or alternatively, one or more computer systems 600 may be used, for example, to implement any of the embodiments discussed herein, as well as combinations and sub-combinations thereof.

Computer system 600 may include one or more processors (also called central processing units, or CPUs), such as a processor 604. Processor 604 may be connected to a communication infrastructure or bus 606.

Computer system 600 may also include user input/output device(s) 603, such as monitors, keyboards, pointing devices, etc., which may communicate with communication infrastructure 606 through user input/output interface(s) 602.

One or more of processors 604 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 600 may also include a main or primary memory 608, such as random access memory (RAM). Main memory 608 may include one or more levels of cache. Main memory 608 may have stored therein control logic (i.e., computer software) and/or data.

Computer system 600 may also include one or more secondary storage devices or memory 610. Secondary memory 610 may include, for example, a hard disk drive 612 and/or a removable storage device or drive 614. Removable storage drive 614 may be a floppy disk drive, a magnetic tape drive, a compact disk drive, an optical storage device, tape backup device, and/or any other storage device/drive.

Removable storage drive 614 may interact with a removable storage unit 618. Removable storage unit 618 may include a computer usable or readable storage device having stored thereon computer software (control logic) and/or data. Removable storage unit 618 may be a floppy disk, magnetic tape, compact disk, DVD, optical storage disk, and/ any other computer data storage device. Removable storage drive 614 may read from and/or write to removable storage unit 618.

Secondary memory 610 may include other means, devices, components, instrumentalities or other approaches for allowing computer programs and/or other instructions and/or data to be accessed by computer system 600. Such means, devices, components, instrumentalities or other approaches may include, for example, a removable storage unit 622 and an interface 620. Examples of the removable storage unit 622 and the interface 620 may include a program cartridge and cartridge interface (such as that found in video game devices), a removable memory chip (such as an EPROM or PROM) and associated socket, a memory stick and USB or other port, a memory card and associated memory card slot, and/or any other removable storage unit and associated interface.

Computer system 600 may further include a communication or network interface 624. Communication interface 624 may enable computer system 600 to communicate and interact with any combination of external devices, external networks, external entities, etc. (individually and collectively referenced by reference number 628). For example, communication interface 624 may allow computer system 600 to communicate with external or remote devices 628 over communications path 626, which may be wired and/or wireless (or a combination thereof), and which may include any combination of LANs, WANs, the Internet, etc. Control logic and/or data may be transmitted to and from computer system 600 via communication path 626.

Computer system 600 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 600 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 600 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture including a tangible, non-transitory computer useable or readable medium having control logic (software) stored thereon may also be referred to herein as a computer program product or program storage device. This includes, but is not limited to, computer system 600, main memory 608, secondary memory 610, and removable storage units 618 and 622, as well as tangible articles of manufacture embodying any combination of the foregoing. Such control logic, when executed by one or more data processing devices (such as computer system 600 or processor(s) 604), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 6. In particular, embodiments may operate with software, hardware, and/or operating system implementations other than those described herein.

### Conclusion

It is to be appreciated that the Detailed Description section, and not any other section, is intended to be used to interpret the claims. Other sections may set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries may be defined as long as the specified functions and relationships (or equivalents thereof) are appropriately performed. Also, alternative embodiments may perform functional blocks, steps, operations, methods, etc. using orderings different than those described herein.

References herein to “one embodiment,” “an embodiment,” “an example embodiment,” or similar phrases, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A computer-implemented method for providing a user experience to media devices via a network based on optimization of an objective function of an online optimizer, the computer-implemented method comprising: generating, by at least one processor, a surrogate model comprising an updatable statistical model of one or more mappings from candidate configurations of tunable parameters of a target model to values of the objective function that are indicative of a performance measure of the target model, wherein the tunable parameters include a continuous parameter having a continuous range of selectable values; selecting, using an acquisition function of the online optimizer and outputs from the surrogate model, candidate configurations of the tunable parameters; determining, by applying the objective function to the target model configured with respective ones of the selected candidate configurations, objective-function values that are indicative of performance measures of the target model for the selected candidate configurations; updating the surrogate model using the selected candidate configurations and the objective-function values; selecting, based on the updated surrogate model and an iteration termination condition, a configuration of the tunable parameters that include the continuous parameter having a value associated with an extremum of the performance measures of the target model; and providing, using the target model and the selected configuration, the user experience to one or more of the media devices.

2. The computer-implemented method of claim 1, wherein the online optimizer is a Bayesian optimizer.

3. The computer-implemented method of claim 1, further comprising: updating the acquisition function using the updated surrogate model; and determining, using the updated acquisition function, a candidate configuration of the tunable parameters that includes the continuous parameter.

4. The computer-implemented method of claim 1, further comprising receiving, from one or more of the media devices, usage data associated with the user experience.

5. The computer-implemented method of claim 4, further comprising applying a Bayesian noise filter to the usage data.

6. The computer-implemented method of claim 4, wherein determining the objective-function values comprises processing the usage data based on outputs of the target model configured with the respective ones of the selected candidate configurations.

7. The computer-implemented method of claim 4, further comprising extracting performance measures from the usage data based on outputs of the target model configured with the respective ones of the selected candidate configurations.

8. The computer-implemented method of claim 7, further comprising aggregating the extracted performance measures.

9. A system, comprising: one or more memories; and at least one processor each coupled to at least one of the memories and configured to perform operations comprising: generating a surrogate model comprising an updatable statistical model of one or more mappings from candidate configurations of tunable parameters of a target model to values of an objective function of an online optimizer that are indicative of a performance measure of the target model, wherein the tunable parameters include a continuous parameter having a continuous range of selectable values; selecting, using an acquisition function of the online optimizer and outputs from the surrogate model, candidate configurations of the tunable parameters; determining, by applying the objective function to the target model configured with respective ones of the selected candidate configurations, objective-function values that are indicative of performance measures of the target model for the selected candidate configurations; updating the surrogate model using the selected candidate configurations and the objective-function values; selecting, based on the updated surrogate model and an iteration termination condition, a configuration of the tunable parameters that includes the continuous parameter having a value associated with an extremum of the performance measures of the target model; and providing, using the target model and the selected configuration, a user experience to one or more media devices.

10. The system of claim 9, wherein the online optimizer is a Bayesian optimizer.

11. The system of claim 9, the operations further comprising: updating the acquisition function using the updated surrogate model; and determining, using the updated acquisition function, a candidate configuration of the tunable parameters that includes the continuous parameter.

12. The system of claim 9, the operations further comprising receiving, from one or more of the media devices, usage data associated with the user experience.

13. The system of claim 12, the operations further comprising applying a Bayesian noise filter to the usage data.

14. The system of claim 12, wherein determining the objective-function values comprises processing the usage data based on outputs of the target model configured with the respective ones of the selected candidate configurations.

15. The system of claim 12, the operations further comprising extracting performance measures from the usage data based on outputs of the target model configured with the respective ones of the selected candidate configurations.

16. The system of claim 15, aggregating the extracted performance measures.

17. A non-transitory computer-readable medium having instructions stored thereon that, when executed by at least one computing device, cause the at least one computing device to perform operations comprising: generating a surrogate model comprising an updatable statistical model of one or more mappings from candidate configurations of tunable parameters of a target model to values of an objective function of an online optimizer that are indicative of a performance measure of the target model, wherein the tunable parameters include a continuous parameter having a continuous range of selectable values; selecting, using an acquisition function of the online optimizer and outputs from the surrogate model, candidate configurations of the tunable parameters; determining, by applying the objective function to the target model configured with respective ones of the selected candidate configurations, objective-function values that are indicative of performance measures of the target model for the selected candidate configurations; updating the surrogate model using the selected candidate configurations and the objective-function values; selecting, based on the updated surrogate model and an iteration termination condition, a configuration of the tunable parameters that includes the continuous parameter having a value associated with an extremum of the performance measures of the target model; and providing, using the target model and the selected configuration, a user experience to one or more media devices.

18. The non-transitory computer-readable medium of claim 17, wherein the online optimizer is a Bayesian optimizer.

19. The non-transitory computer-readable medium of claim 17, the operations further comprising: updating the acquisition function using the updated surrogate model; and determining, using the updated acquisition function, a candidate configuration of the tunable parameters that includes the continuous parameter.

20. The non-transitory computer-readable medium of claim 17, the operations further comprising receiving, from one or more of the media devices, usage data associated with the user experience, wherein determining the objective-function values comprises processing the usage data based on outputs of the target model configured with the respective ones of the selected candidate configurations.
